(19) United States
(12) Patent Application Publication
(10) Pub. No.: US 2023/0265688 A1
(43) Pub. Date: Aug. 24, 2023

(54) VEHICLE DOOR LOCK DEVICE

(71) Applicant: AISIN CORPORATION, Kariya (JP)

(72) Inventors: Hisashi ITONAGA, Kariya-shi (JP); Natsumi ONODERA, Kariya-shi (JP); Toshitsugu ODA, Kariya-shi (JP); Yoshihiro YAMAGUCHI, Kariya-shi (JP); Shinsuke TAKAYANAGI, Kariya-shi (JP)

(73) Assignee: AISIN CORPORATION, Kariya (JP)

(21) Appl. No.: 18/154,111

(22) Filed: Jan. 13, 2023

(30) Foreign Application Priority Data
Feb. 21, 2022 (JP) 2022-024899

(51) Int. Cl. E05B 81/14; E05B 83/38; E05B 83/40

(52) U.S. Cl. CPC E05B 81/14; E05B 83/38; E05B 83/40

(57) ABSTRACT

A vehicle door lock device includes a latch configured to rotate between a fully-latched position and an unlatched position, a pawl configured to rotate between a restriction position where a rotation of the latch from the fully-latched position to the unlatched position is restricted and a permission position where the rotation is permitted, a latch support shaft, a pawl support shaft, a first base to which a first end of the latch support shaft and a first end of the pawl support shaft are fixed, a second base to which a second end of the latch support shaft and a second end of the pawl support shaft are fixed, and a coupling member that couples the first base and the second base. A first end of the coupling member is fixed to the first base, and a second end of the coupling member is fixed to the second base.

### CROSS REFERENCE TO RELATED APPLICATIONS

This application is based on and claims priority under 35 U.S.C. § 119 to Japanese Patent Application 2022-024899, filed on Feb. 21, 2022, the entire content of which is incorporated herein by reference.

### TECHNICAL FIELD

This disclosure relates to a vehicle door lock device.

### BACKGROUND DISCUSSION

JP 2018-168592A (Reference 1) discloses a vehicle including: a vehicle body having a door opening portion; and a door that opens and closes the door opening portion. The vehicle body is provided with a striker. Meanwhile, the door is provided with a door lock device. The door lock device includes a latch that rotates between a fully-latched position where the latch is lockable to the striker and an unlatched position where the latch is unlockable to the striker, a latch support shaft that supports the latch, and a first bracket and a second bracket that respectively support both end portions of the latch support shaft.

When the door is to be closed toward a fully-closed position where the door opening portion is fully closed, the latch of the door lock device is displaced from the unlatched position to the fully-latched position by coming into contact the striker. In this way, the door lock device is coupled to the striker, whereby the door is restrained onto the vehicle body at the fully-closed position.

Depending on a type of the vehicle on which the door lock device is mounted, the door lock device as described above may be required to have a higher coupling strength to the striker.

### SUMMARY

According to an aspect of this disclosure, a vehicle door lock device includes: a latch configured to rotate between a fully-latched position where the latch is lockable to a striker and an unlatched position where the latch is unlockable to the striker; a pawl configured to rotate between a restriction position where a rotation of the latch from the fully-latched position to the unlatched position is restricted and a permission position where the rotation of the latch from the fully-latched position to the unlatched position is permitted; a latch support shaft that rotatably supports the latch; a pawl support shaft that rotatably supports the pawl; a first base to which a first end of the latch support shaft and a first end of the pawl support shaft are fixed; a second base to which a second end of the latch support shaft and a second end of the pawl support shaft are fixed; and a coupling member that couples the first base and the second base. A first end of the coupling member is fixed to the first base, and a second end of the coupling member is fixed to the second base.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view showing a schematic configuration of a vehicle;

FIG. 2 is a cross-sectional view taken along a line 2-2 in FIG. 1;

FIG. 3 is an exploded perspective view showing a center lock device;

FIG. 4 is an exploded perspective view showing the center lock device;

FIG. 5 is a front view showing the center lock device with a partial configuration omitted;

FIG. 6 is a rear view showing the center lock device with a partial configuration omitted;

FIG. 7 is a front view showing the center lock device in a released state;

FIG. 8 is a front view showing the center lock device in a locked state;

FIG. 9 is a cross-sectional view showing an example of a positional relationship between the center lock device and a center striker when an impact acts on the vehicle; and

FIG. 10 is a perspective view showing an example of a deformed portion of the center lock device when an impact acts on the vehicle.

### DETAILED DESCRIPTION

Hereinafter, an embodiment of a vehicle in which a vehicle door lock device is embodied as a center lock device will be described. In the drawings, an X axis is an axis extending in a vehicle front-rear direction, a Y axis is an axis extending in a vehicle width direction, and a Z axis is an axis extending in a vehicle upper-lower direction. In the following description, the vehicle front-rear direction is also referred to as a front-rear direction, the vehicle width direction is also referred to as a width direction, and the vehicle upper-lower direction is also referred to as an upper-lower direction.

### Vehicle 10

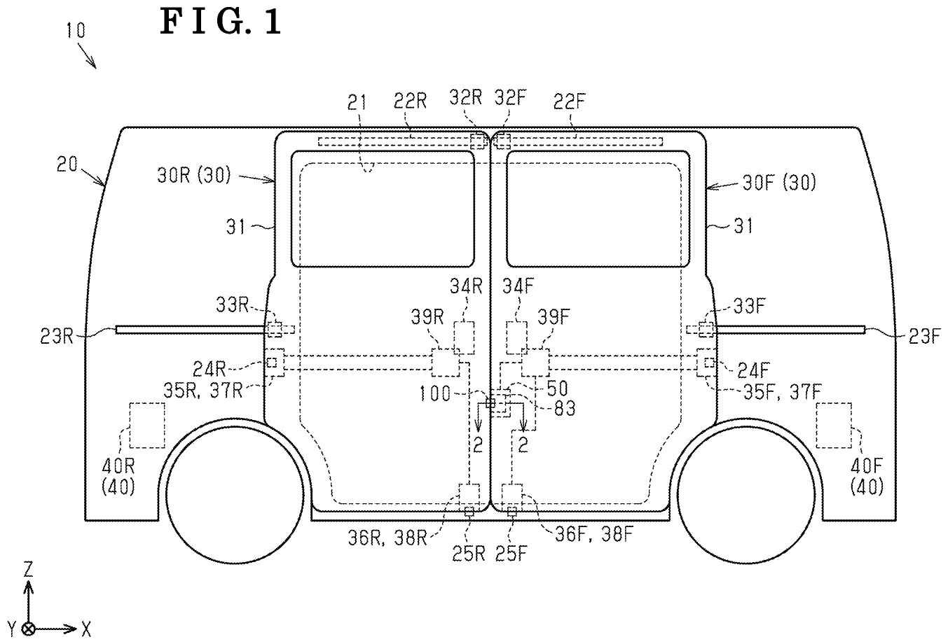

As shown in FIG. 1, a vehicle 10 includes a vehicle body 20, a slide door 30, and a door drive unit 40.

### Vehicle Body 20

As shown in FIG. 1, the vehicle body 20 has a door opening portion 21, upper rails 22F and 22R, center rails 23F and 23R, a front striker 24F, a rear striker 24R, and lower strikers 25F and 25R.

The upper rails 22F and 22R are disposed above the door opening portion 21, and the center rails 23F and 23R are disposed below the upper rails 22F and 22R. The upper rail 22F is disposed in front of a center of the door opening portion 21 in the front-rear direction, and the center rail 23F is disposed in front of the door opening portion 21. The upper rail 22R is disposed behind the center of the door opening portion 21 in the front-rear direction, and the center rail 23R is disposed behind the door opening portion 21. A longitudinal direction of the upper rails 22F and 22R and the center rails 23F and 23R is mainly the front-rear direction.

The front striker 24F is disposed in front of the door opening portion 21. The rear striker 24R is disposed behind the door opening portion 21. The lower strikers 25F and 25R are disposed at a lower end portion of the door opening portion 21 at a center of the door opening portion 21 in the front-rear direction. The lower striker 25F and the lower striker 25R are positioned adjacent to each other in the front-rear direction.

### Slide Door 30

As shown in FIG. 1, the slide door 30 includes a front door 30F for opening and closing a front half range of the door opening portion 21, and a rear door 30R for opening and closing a rear half range of the door opening portion 21.

The front door 30F is opened by being moved forward, and closed by being moved rearward. Meanwhile, the rear door 30R is opened by being moved rearward, and closed by being moved forward. That is, the front door 30F and the rear door 30R are opened by being moved away from each other, and closed by being moved toward each other. Thus, the front door 30F and the rear door 30R are opened and closed between a “fully-opened position” where the door opening portion 21 is fully opened and a “fully-closed position” where the door opening portion 21 is fully closed.

### Front Door 30F

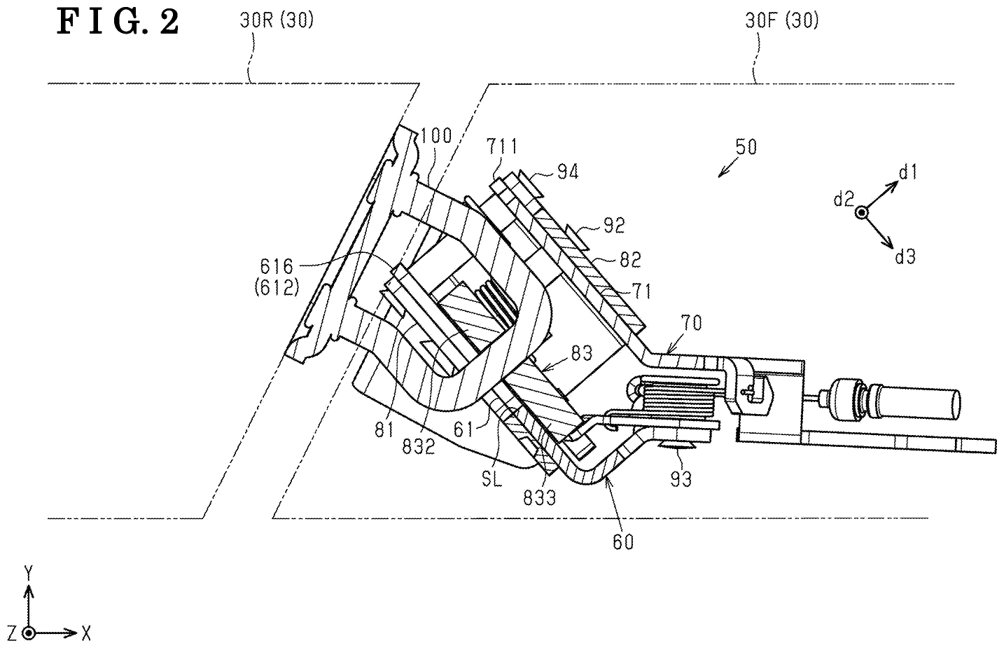

As shown in FIGS. 1 and 2, the front door 30F includes a door main body 31, an upper guide unit 32F, a center guide unit 33F, and a door handle 34F. The front door 30F includes a front lock device 35F, a center lock device 50, a lower lock device 36F, a front lock drive device 37F, a lower lock drive device 38F, and a remote controller 39F.

The door main body 31 has a rectangular shape corresponding to a front half shape of the door opening portion 21 in a side view. The door main body 31 includes an inner panel and an outer panel that are spaced apart from each other in the width direction. Some of components of the front door 30F are accommodated in a space between the inner panel and the outer panel.

The upper guide unit 32F is fixed to an upper rear end portion of the door main body 31. The upper guide unit 32F is engaged with the upper rail 22F so as to be movable in the longitudinal direction of the upper rail 22F. The center guide unit 33F is fixed to a front end portion of the door main body 31 at a center portion of the door main body 31 in the upper-lower direction. The center guide unit 33F is engaged with the center rail 23F so as to be movable in the longitudinal direction of the center rail 23F. When the upper guide unit 32F and the center guide unit 33F are moved along the upper rail 22F and the center rail 23F, respectively, the front door 30F can be moved in the front-rear direction with respect to the vehicle body 20.

The door handle 34F is an inside door handle provided on a surface of the door main body 31 facing the inside of the vehicle 10. The door handle 34F may be an outside door handle provided on a surface of the door main body 31 facing the outside of the vehicle 10.

The front lock device 35F is provided at a front end portion of the door main body 31 at a center portion of the door main body 31 in the upper-lower direction. The front lock device 35F is configured to be switchable between a locked state where the front lock device 35F is locked to the front striker 24F and a released state where the front lock device 35F is not locked to the front striker 24F. When the front lock device 35F is switched to the locked state, the front lock device 35F restrains a front end portion of the front door 30F positioned at the fully-closed position to the vehicle body 20. Meanwhile, when the front lock device 35F is switched to the released state, the front lock device 35F releases the restraint of the front door 30F positioned at the fully-closed position.

The center lock device 50 is provided at a rear end portion of the door main body 31 at the center portion of the door main body 31 in the upper-lower direction. The center lock device 50 is configured to be switchable between a locked state where the center lock device 50 is locked to a center striker 100 of the rear door 30R and a released state where the center lock device 50 is not locked to the center striker 100, which will be described later. When the center lock device 50 is switched to the locked state, the center lock device 50 couples a rear end portion of the front door 30F and a front end portion of the rear door 30R that are positioned at the fully-closed position. Meanwhile, when the center lock device 50 is switched to the released state, the center lock device 50 releases the coupling between the front door 30F and the rear door 30R that are positioned at the fully-closed position.

The lower lock device 36F is provided at a lower rear end portion of the door main body 31. The lower lock device 36F is configured to be switchable between a locked state where the lower lock device 36F is locked to the lower striker 25F and a released state where the lower lock device 36F is not locked to the lower striker 25F. When the lower lock device 36F is switched to the locked state, the lower lock device 36F restrains a lower end portion of the front door 30F positioned at the fully-closed position onto the vehicle body 20. Meanwhile, when the lower lock device 36F is switched to the released state, the lower lock device 36F releases the restraint of the front door 30F positioned at the fully-closed position.

The front lock drive device 37F shifts the front lock device 35F from the released state to the locked state, or shifts the front lock device 35F from the locked state to the released state. The front lock drive device 37F shifts the front lock device 35F from the released state to the locked state after the front door 30F is closed to a substantially fully-closed position in the vicinity of the fully-closed position. Meanwhile, the front lock drive device 37F shifts the front lock device 35F from the locked state to the released state when opening the front door 30F from the fully-closed position.

The lower lock drive device 38F shifts the lower lock device 36F from the released state to the locked state. Specifically, the lower lock drive device 38F shifts the lower lock device 36F to the locked state after the front lock drive device 37F shifts the front lock device 35F to the locked state, that is, after the front door 30F is closed to the fully-closed position.

The remote controller 39F relays power transmitted among the door handle 34F, the front lock drive device 37F, the center lock device 50, and the lower lock device 36F. Specifically, when the front lock drive device 37F is to shift the front lock device 35F to the released state, the remote controller 39F transmits the power to the center lock device 50 and the lower lock device 36F. Then, the remote controller 39F shifts the center lock device 50 and the lower lock device 36F from the locked state to the released state. When a user operates the door handle 34F, the remote controller 39F transmits the power to the front lock device 35F, the center lock device 50, and the lower lock device 36F. Then, the remote controller 39F shifts the front lock device 35F, the center lock device 50, and the lower lock device 36F from the locked state to the released state.

### Rear Door 30R

As shown in FIGS. 1 and 2, the rear door 30R includes a door main body 31, an upper guide unit 32R, a center guide unit 33R, and a door handle 34R. The rear door 30R includes a rear lock device 35R, a lower lock device 36R, a rear lock drive device 37R, a lower lock drive device 38R, a remote controller 39R, and the center striker 100.

The rear door 30R is configured in substantially the same manner as the front door 30F. A difference from the front door 30F is that the rear lock device 35R and the rear lock drive device 37R are provided instead of the front lock device 35F and the front lock drive device 37F, and the center striker 100 is provided instead of the center lock device 50. Therefore, a description of the configuration of the rear door 30R except for the center striker 100 will be omitted.

As shown in FIGS. 1 and 2, the center striker 100 is installed at a front end portion of the rear door 30R at a center portion of the rear door 30R in the upper-lower direction. In other words, the center striker 100 is installed at a position facing the center lock device 50 of the front door 30F in the front-rear direction. The center striker 100 is an object to be locked by the center lock device 50. As shown in FIG. 2, the center striker 100 has a U shape in the upper-lower direction in a plan view.

### Door Drive Unit 40

As shown in FIG. 1, the door drive unit 40 includes a front door drive unit 40F that drives the front door 30F in an opening-closing direction, and a rear door drive unit 40R that drives the rear door 30R in an opening-closing direction. The front door drive unit 40F and the rear door drive unit 40R each include, for example, a motor and a transmission mechanism that transmits power of the motor to the slide door 30. The transmission mechanism of the front door drive unit 40F and the rear door drive unit 40R may include a pulley and a belt, or may include a drum and a cable. The front door drive unit 40F and the rear door drive unit 40R may be incorporated in the slide door 30. The front door 30F and the rear door 30R can be said to be so-called power slide doors, considering that they are opened and closed by the front door drive unit 40F and the rear door drive unit 40R, respectively.

### Center Lock Device 50

Hereinafter, the center lock device 50 will be described in detail. In the present embodiment, the center lock device 50 corresponds to a “door lock device”, and the center striker 100 to be locked by the center lock device 50 corresponds to a “striker”.

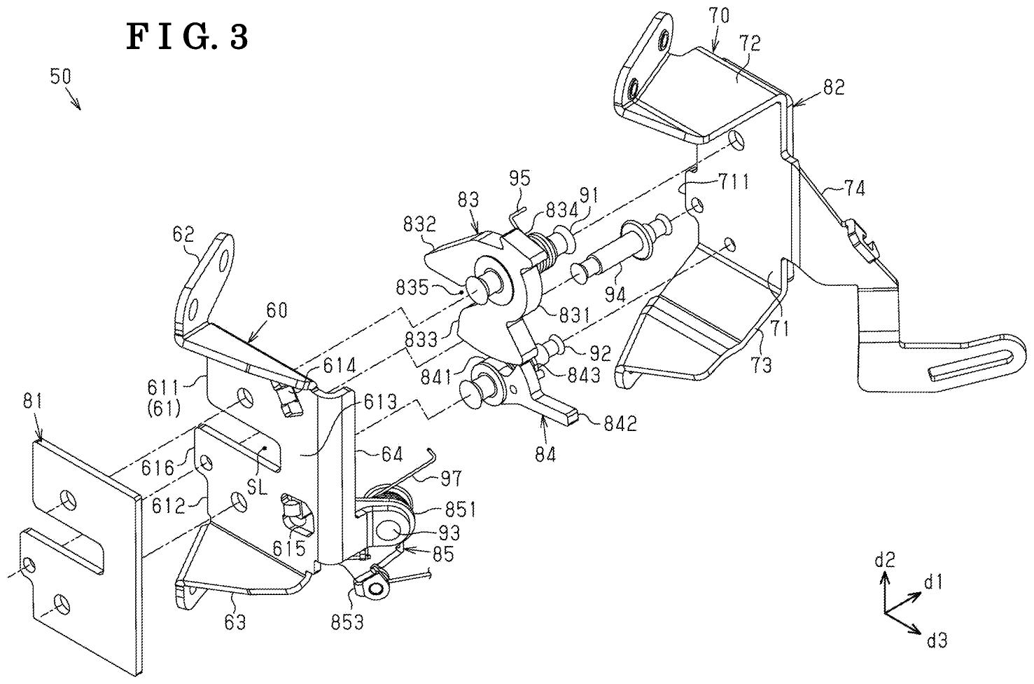

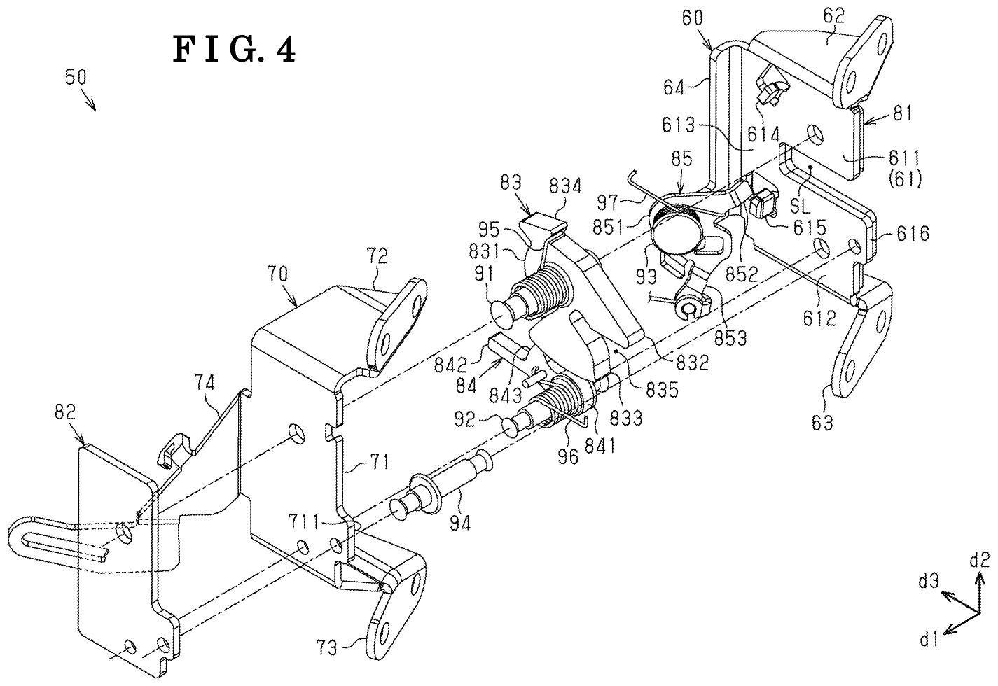

As shown in FIGS. 3 and 4, the center lock device 50 includes a first base 60, a second base 70, a first reinforcing plate 81, a second reinforcing plate 82, a latch 83, a pawl 84, and a release lever 85. Further, the center lock device 50 includes a latch support shaft 91, a pawl support shaft 92, a lever support shaft 93, a coupling shaft 94, a latch spring 95, a pawl spring 96, and a lever spring 97. In the following description, a direction in which the latch support shaft 91 extends is referred to as a first direction d1, a direction orthogonal to the first direction d1 is referred to as a second direction d2, and a direction orthogonal to both the first direction d1 and the second direction d2 is referred to as a third direction d3. As shown in FIG. 2, the second direction d2 is a direction same as the upper-lower direction.

### First Base 60 and First Reinforcing Plate 81

As shown in FIGS. 3 and 4, the first base 60 includes a first main plate 61, two first fixing plates 62 and 63, and a first support plate 64. The first base 60 is formed by, for example, pressing a metal plate. Therefore, in the present embodiment, plate thicknesses of the first main plate 61, the first fixing plates 62 and 63, and the first support plate 64 are constant.

The first main plate 61 has a rectangular plate shape. The first main plate 61 includes a latch support wall 611 that supports the latch 83, a pawl support wall 612 that supports the pawl 84, and a coupling wall 613 that couples the latch support wall 611 and the pawl support wall 612. The first main plate 61 includes a latch stopper 614 that limits an operation range of the latch 83 and a pawl stopper 615 that limits an operation range of the pawl 84. Further, the first main plate 61 has a slit SL extending between the latch support wall 611 and the pawl support wall 612.

When viewed from the first direction d1, the latch support wall 611 has a rectangular shape with the second direction d2 as a lateral direction and the third direction d3 as a longitudinal direction. When viewed from the first direction d1, the pawl support wall 612 has a rectangular shape with the second direction d2 as a lateral direction and the third direction d3 as a longitudinal direction. The pawl support wall 612 includes a first extension wall 616 extending in the third direction d3 at a position close to an opening of the slit SL. The first extension wall 616 is a portion of the pawl support wall 612 that does not face the latch support wall 611, with the slit SL interposed therebetween. The coupling wall 613 is positioned between the latch support wall 611 and the pawl support wall 612 in the second direction d2, and is adjacent to the slit SL in the third direction d3. In this respect, a side surface of the coupling wall 613 can be said to be a bottom surface of the slit SL. In the present embodiment, the latch support wall 611 corresponds to a “first wall portion”, and the pawl support wall 612 corresponds to a “second wall portion”. The latch stopper 614 is provided on the latch support wall 611. The latch stopper 614 is bent from the latch support wall 611 in the first direction d1. The pawl stopper 615 is provided on the pawl support wall 612. The pawl stopper 615 is bent from the pawl support wall 612 in the first direction d1. The slit SL extends in the third direction d3 with the first direction d1 as a width direction. The slit SL is a portion through which the center striker 100 of the rear door 30R passes while the front door 30F is being opened and closed. Therefore, a width of the slit SL is larger than a shaft diameter of the center striker 100.

The two first fixing plates 62 and 63 respectively extend from both end portions of the first main plate 61 in the second direction d2. Specifically, the first fixing plate 62 extends so as to be bent from an end portion of the latch support wall 611 in the second direction d2. The first fixing plate 63 extends so as to be bent from an end portion of the pawl support wall 612 in the second direction d2. The two first fixing plates 62 and 63 are used to fix the center lock device 50 to the door main body 31. The first support plate 64 extends so as to be bent from an end portion of the first main plate 61 in the third direction d3.

As shown in FIG. 3, the first reinforcing plate 81 has a rectangular plate shape. Specifically, the first reinforcing plate 81 has a shape same as that of the first main plate 61 of the first base 60. That is, the first reinforcing plate 81 has a configuration corresponding to the latch support wall 611, the pawl support wall 612, the coupling wall 613, and the slit SL of the first main plate 61. A plate thickness of the first reinforcing plate 81 may be equal to or different from the plate thickness of the first main plate 61.

### Second Base 70 and Second Reinforcing Plate 82

As shown in FIGS. 3 and 4, the second base 70 includes a second main plate 71, two second fixing plates 72 and 73, and a second support plate 74. The second base 70 is formed by, for example, pressing a metal plate. Therefore, in the present embodiment, plate thicknesses of the second main plate 71, the second fixing plates 72 and 73, and the second support plate 74 are constant.

When viewed from the first direction d1, the second main plate 71 has a rectangular shape with the second direction d2 as a longitudinal direction and the third direction d3 as a lateral direction. The second main plate 71 includes a second extension wall 711 protruding in the third direction d3 at a position shifted from a center portion in the second direction d2. The second extension wall 711 has a rectangular shape when viewed from the first direction d1. The second extension wall 711 of the second main plate 71 is a portion corresponding to the first extension wall 616 of the first main plate 61.

The two second fixing plates 72 and 73 extend so as to be respectively bent from both end portions of the second main plate 71 in the second direction d2. The two second fixing plates 72 and 73 are used when fixing the center lock device 50 to the door main body 31 of the front door 30F. The second support plate 74 extends so as to be bent from an end portion of the second main plate 71 in the third direction d3.

As shown in FIG. 4, the second reinforcing plate 82 has a rectangular plate shape. Specifically, the second reinforcing plate 82 has a shape same as that of the second main plate 71 of the second base 70. That is, the second reinforcing plate 82 includes the second extension wall 711. A plate thickness of the second reinforcing plate 82 may be equal to or different from the plate thickness of the second main plate 71.

### Latch 83, Latch Support Shaft 91, and Latch Spring 95

As shown in FIGS. 3 and 4, the latch 83 includes a base portion 831, and a first protrusion 832, a second protrusion 833, and a third protrusion 834 that protrude from the base portion 831. The first protrusion 832, the second protrusion 833, and the third protrusion 834 extend in a direction orthogonal to a plate thickness direction of the base portion 831. The first protrusion 832, the second protrusion 833, and the third protrusion 834 are arranged side by side in a circumferential direction of the base portion 831. A space between the first protrusion 832 and the second protrusion 833 serves as a striker entering groove 835 into which the center striker 100 enters. A width of the striker entering groove 835 is slightly larger than the shaft diameter of the center striker 100. The first protrusion 832 corresponds to a “locking portion”.

The latch support shaft 91 has a columnar shape. The latch support shaft 91 penetrates the base portion 831 of the latch 83 in the plate thickness direction. Thus, the latch support shaft 91 rotatably supports the latch 83. The latch spring 95 is a so-called torsion coil spring. The latch spring 95 is supported by the latch support shaft 91 by inserting the latch support shaft 91 into a coil portion thereof. The latch spring 95 is a component for biasing the latch 83 around an axis of the latch support shaft 91. The latch spring 95 may be a spring of any other type as long as it can bias the latch 83.

### Pawl 84, Pawl Support Shaft 92, and Pawl Spring 96

As shown in FIGS. 3 and 4, the pawl 84 includes a base portion 841, an extension portion 842 extending from the base portion 841 in a radial direction, and a locking claw 843 extending from the extension portion 842 in a direction intersecting a longitudinal direction of the extension portion 842. The pawl support shaft 92 has a columnar shape. The pawl support shaft 92 penetrates the base portion 841 of the pawl 84 in a plate thickness direction. Thus, the pawl support shaft 92 rotatably supports the pawl 84.

The pawl spring 96 is a so-called torsion coil spring. The pawl spring 96 is supported by the pawl support shaft 92 by inserting the pawl support shaft 92 into a coil portion. The pawl spring 96 is a component for biasing the pawl 84 around an axis of the pawl support shaft 92. The pawl spring 96 may be a spring of any other type as long as it can bias the pawl 84.

### Coupling Shaft 94

As shown in FIGS. 3 and 4, the coupling shaft 94 has a rod shape. The coupling shaft 94 has a configuration substantially the same as that of the latch support shaft 91 and the pawl support shaft 92. In the present embodiment, the coupling shaft 94 corresponds to an example of a “coupling member”. In the present embodiment, the coupling shaft 94 has a disk-shaped flange, but may have a simple cylindrical shape.

### Release Lever 85, Lever Support Shaft 93, and Lever Spring 97

As shown in FIGS. 3 and 4, the release lever 85 includes a base portion 851, and a first lever 852 and a second lever 853 extending from the base portion 851. The first lever 852 is a portion for operating the extension portion 842 of the pawl 84, and the second lever 853 is a portion to which power is transmitted from the remote controller 39F. The lever support shaft 93 has a columnar shape. The lever support shaft 93 penetrates the base portion 851 of the release lever 85 in a plate thickness direction. Thus, the lever support shaft 93 rotatably supports the release lever 85.

The lever spring 97 is a so-called torsion coil spring. The lever spring 97 is supported by the lever support shaft 93 by inserting the lever support shaft 93 into a coil portion. The lever spring 97 is a component for biasing the release lever 85 around an axis of the lever support shaft 93. The lever spring 97 may be a spring of any other type of as long as it can bias the release lever 85.

### Overall Configuration of Center Lock Device 50

As shown in FIGS. 3 to 6, a first end of the latch support shaft 91, a first end of the pawl support shaft 92, and a first end of the coupling shaft 94 are fixed to the first main plate 61 of the first base 60. Specifically, the first end of the latch support shaft 91 is fixed to the latch support wall 611 of the first main plate 61, and the first end of the pawl support shaft 92 and the first end of the coupling shaft 94 are fixed to the pawl support wall 612 of the first main plate 61. Meanwhile, a second end of the latch support shaft 91, a second end of the pawl support shaft 92, and a second end of the coupling shaft 94 are fixed to the second main plate 71 of the second base 70.

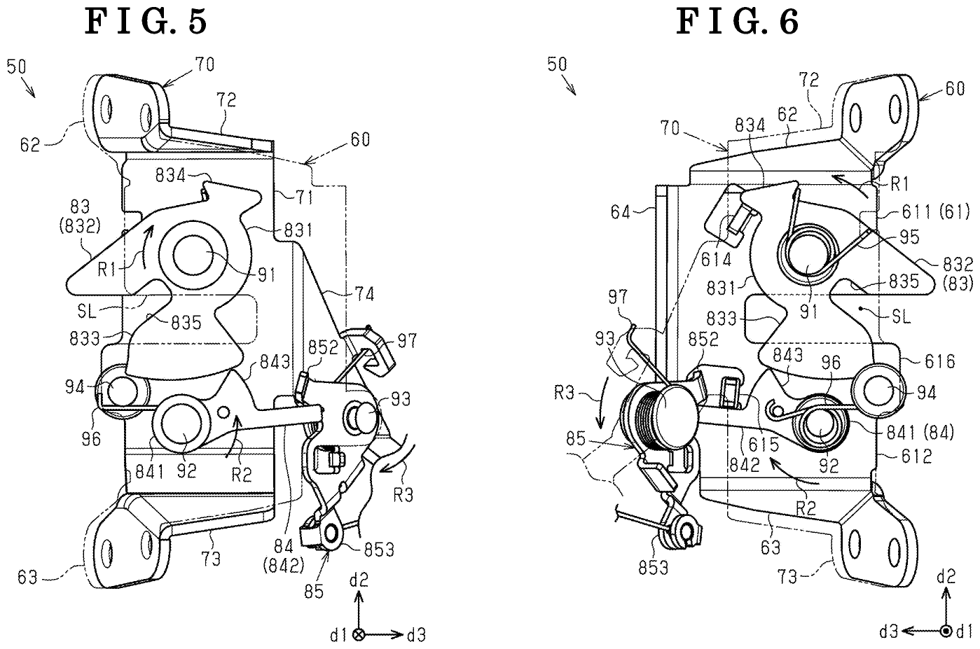

As shown in FIGS. 5 and 6, the first end of the coupling shaft 94 is fixed to the first extension wall 616 of the first main plate 61, and a second end of the coupling shaft 94 is fixed to the second extension wall 711 of the second main plate 71. Therefore, when the center lock device 50 is viewed from the first direction d1, the coupling shaft 94 is positioned closer in the second direction d2 to the slit SL than to a boundary between the pawl support wall 612 and the first fixing plate 63. In other words, the coupling shaft 94 is positioned close in the second direction d2 to an end surface of the pawl support wall 612 that faces the slit SL. When the center lock device 50 is viewed from the first direction d1, the coupling shaft 94 is positioned closer in the third direction d3 to the opening of the slit SL than to the bottom portion of the slit SL.

The latch support shaft 91, the pawl support shaft 92, and the coupling shaft 94 may be fixed to the first main plate 61 and the second main plate 71 by caulking. In the present embodiment, axial directions of the latch support shaft 91, the pawl support shaft 92, and the coupling shaft 94 are all oriented in the first direction d1. That is, the coupling shaft 94 extends along the latch support shaft 91 and the pawl support shaft 92.

Both end portions of the latch support shaft 91, the pawl support shaft 92, and the coupling shaft 94 are fixed to the first base 60 and the second base 70, respectively, so that the first base 60 and the second base 70 are integrated. At this time, the first main plate 61 and the second main plate 71 face each other with a gap therebetween. The latch 83 and the latch spring 95 that are supported by the latch support shaft 91 and the pawl 84 and the pawl spring 96 that are supported by the pawl support shaft 92 are accommodated between the first main plate 61 and the second main plate 71.

As shown in FIGS. 5 and 6, between the first main plate 61 and the second main plate 71, one end of the latch spring 95 is locked to the third protrusion 834 of the latch 83, and the other end of the latch spring 95 is locked to the second main plate 71 of the second base 70. Thus, as shown in FIG. 6, the latch spring 95 biases the latch 83 in a first rotation direction R1. The latch 83 is positioned by the third protrusion 834 coming into contact with the latch stopper 614 of the first base 60.

As shown in FIGS. 5 and 6, between the first main plate 61 and the second main plate 71, one end of the pawl spring 96 is locked to the pawl 84, and the other end of the pawl spring 96 is locked to the coupling shaft 94. Thus, the pawl spring 96 biases the pawl 84 in a second rotation direction R2. As shown in FIG. 6, the pawl 84 is positioned by the extension portion 842 coming into contact with the pawl stopper 615 of the first base 60. At this time, the locking claw 843 of the pawl 84 faces a circumferential surface of the second protrusion 833 of the latch 83.

As shown in FIGS. 5 and 6, when the first base 60 and the second base 70 are integrated, the first fixing plates 62 and 63 of the first base 60 and the second fixing plates 72 and 73 of the second base 70 are stacked, respectively. Therefore, when the center lock device 50 is to be fixed to the door main body 31, the first fixing plates 62 and 63 and the second fixing plates 72 and 73 that are stacked, respectively, are fixed to the door main body 31 using fastening members.

As shown in FIGS. 5 and 6, a first end of the lever support shaft 93 is fixed to the first support plate 64 of the first base 60. Thus, the release lever 85 is rotatably supported with respect to the first base 60. The first lever 852 of the release lever 85 faces the extension portion 842 of the pawl 84 in a rotation direction of the release lever 85. One end of the lever spring 97 is locked to the release lever 85, and the other end of the lever spring 97 is locked to the second support plate 74 of the second base 70. Thus, the lever spring 97 biases the release lever 85 in a third rotation direction R3. Specifically, the release lever 85 is biased in a direction in which the first lever 852 is separated from the extension portion 842 of the pawl 84.

As shown in FIGS. 3 and 4, the first reinforcing plate 81 is stacked on the first main plate 61 of the first base 60. The first reinforcing plate 81 and the first main plate 61 are integrated by caulking the first end of the latch support shaft 91, the first end of the pawl support shaft 92, and the first end of the coupling shaft 94. Thus, the first reinforcing plate 81 is fixed to the first main plate 61. Similarly, the second reinforcing plate 82 is stacked on the second main plate 71 of the second base 70. The second reinforcing plate 82 and the second main plate 71 are integrated by caulking the second end of the latch support shaft 91, the second end of the pawl support shaft 92, and the second end of the coupling shaft 94. Thus, the second reinforcing plate 82 is fixed to the second main plate 71.

### Operation of Present Embodiment

An operation of closing the slide door 30 will be described with reference to FIGS. 1, 7, and 8.

As shown in FIG. 1, when the slide door 30 is to be closed, the front door 30F is closed to a substantially fully-closed position by the front door drive unit 40F, and the rear door 30R is closed to the substantially fully-closed position by the rear door drive unit 40R. Here, the substantially fully-closed position is a position slightly shifted from the fully-closed position in an opening direction.

When the front door 30F and the rear door 30R reach the substantially fully-closed position, the rear lock device 35R is shifted to the locked state by the rear lock drive device 37R. That is, the rear door 30R is closed from the substantially fully-closed position to the fully-closed position. When the shift of the rear lock device 35R to the locked state is completed, the front lock device 35F is shifted to the locked state by the front lock drive device 37F. That is, the front door 30F is closed from the substantially fully-closed position to the fully-closed position.

When the front door 30F is to be closed to the fully-closed position while the rear door 30R is positioned at the fully-closed position, the rear end portion of the front door 30F approaches the front end portion of the rear door 30R. In other words, the center lock device 50 of the front door 30F approaches the center striker 100 of the rear door 30R. As a result, the center lock device 50 is shifted to the locked state. Hereinafter, an operation of shifting the center lock device 50 to the locked state will be described in detail.

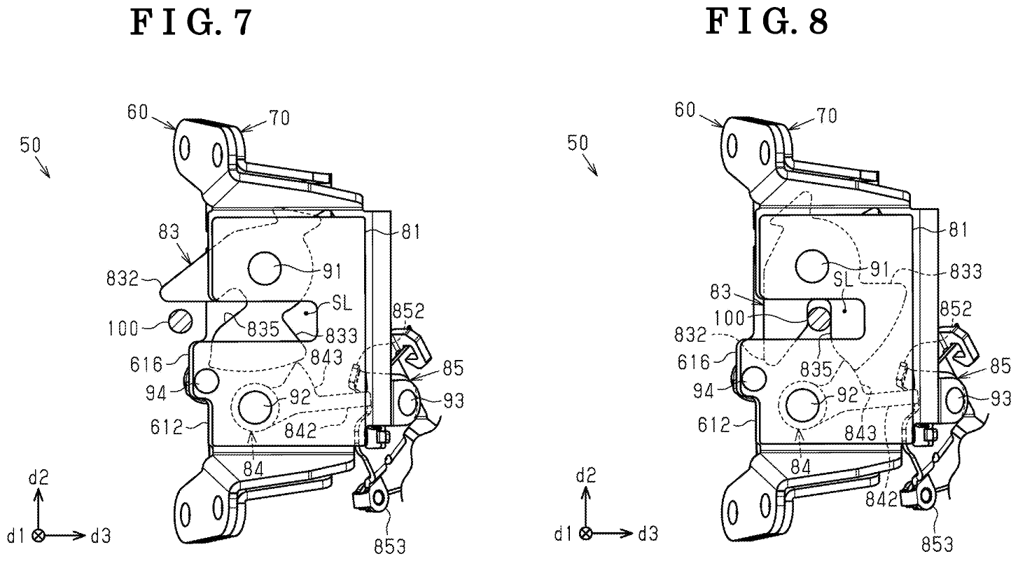

Even when the rear door 30R is positioned at the fully-closed position, the latch 83 of the center lock device 50 does not come into contact with the center striker 100 as shown in FIG. 7 when the front door 30F is positioned at the substantially fully-closed position. Therefore, the latch 83 is positioned at an unlatched position where the latch 83 is unlockable to the center striker 100. When the latch 83 is positioned at the unlatched position, the locking claw 843 of the pawl 84 comes into contact with the circumferential surface of the second protrusion 833 of the latch 83.

When the front door 30F is to be closed from the substantially fully-closed position to the fully-closed position, the center striker 100 relatively enters the slit SL of the first base 60 and the striker entering groove 835 of the latch 83, as shown in FIGS. 7 and 8. At this time, the second protrusion 833 of the latch 83 is pushed by the center striker 100, thereby rotating the latch 83 in a direction opposite to a biasing direction of the latch spring 95. In addition, the locking claw 843 of the pawl 84 slides on the second protrusion 833 of the rotating latch 83.

As shown in FIG. 8, when the locking claw 843 of the pawl 84 stops sliding on the second protrusion 833 of the latch 83, the locking claw 843 of the pawl 84 rotates in accordance with a biasing force of the pawl spring 96. Then, the locking claw 843 of the pawl 84 is locked to the second protrusion 833 of the latch 83. That is, the pawl 84 is displaced to a restriction position. When the pawl 84 is displaced to the restriction position, the latch 83 cannot rotate in accordance with a biasing force of the latch spring 95. That is, even when the center striker 100 does not press the second protrusion 833 of the latch 83, the state where the latch 83 is locked to the center striker 100 is maintained. A position of the latch 83 shown in FIG. 8 is a fully-latched position where the latch 83 is lockable to the center striker 100. In this respect, when the pawl 84 is positioned at the restriction position, the rotation of the latch 83 from the fully-latched position to the unlatched position is restricted. When the latch 83 rotates by being pushed by the center striker 100, the latch 83 may temporarily rotate beyond a locking position.

As shown in FIG. 8, when the latch 83 of the center lock device 50 is positioned at the fully-latched position, a tip end of the first protrusion 832 of the latch 83 overlaps the pawl support wall 612 of the first base 60 in the first direction d1 in a plan view.

After the center lock device 50 is shifted to the locked state, the lower lock devices 36F and 36R are shifted to the locked state by the lower lock drive devices 38F and 38R, respectively. Thus, the front door 30F and the rear door 30R are restrained onto the vehicle body 20, and the front door 30F and the rear door 30R are coupled to each other. That is, the closing of the slide door 30 is completed.

Next, an operation of opening the slide door 30 will be described.

As shown in FIG. 1, when the slide door 30 is to be opened, the front lock drive device 37F and the rear lock drive device 37R are driven. As a result, the front lock device 35F and the rear lock device 35R are shifted to the released state. At this time, the remote controller 39F transmits power transmitted from the front lock device 35F to the lower lock device 36F. As a result, the lower lock device 36F is shifted to the released state. Similarly, the remote controller 39R transmits power transmitted from the rear lock device 35R to the lower lock device 36R. As a result, the lower lock device 36R is shifted to the released state.

Further, the remote controller 39F transmits the power transmitted from the front lock device 35F to the second lever 853 of the release lever 85 of the center lock device 50. As shown in FIG. 8, the release lever 85 rotates in a direction opposite to a biasing direction of the lever spring 97 based on power transmitted from the remote controller 39F. Then, the first lever 852 of the release lever 85 pushes down the extension portion 842 of the pawl 84, thereby rotating the pawl 84 from the restriction position toward the permission position. As a result, the latch 83 is allowed to rotate from the fully-latched position toward the unlatched position based on a biasing force of the latch spring 95. When the latch 83 rotates to the unlatched position, the latch 83 is no longer locked to the center striker 100. As a result, the shift of the center lock device 50 to the released state is completed. Thereafter, the front door 30F is opened by the front door drive unit 40F, and the rear door 30R is opened by the rear door drive unit 40R.

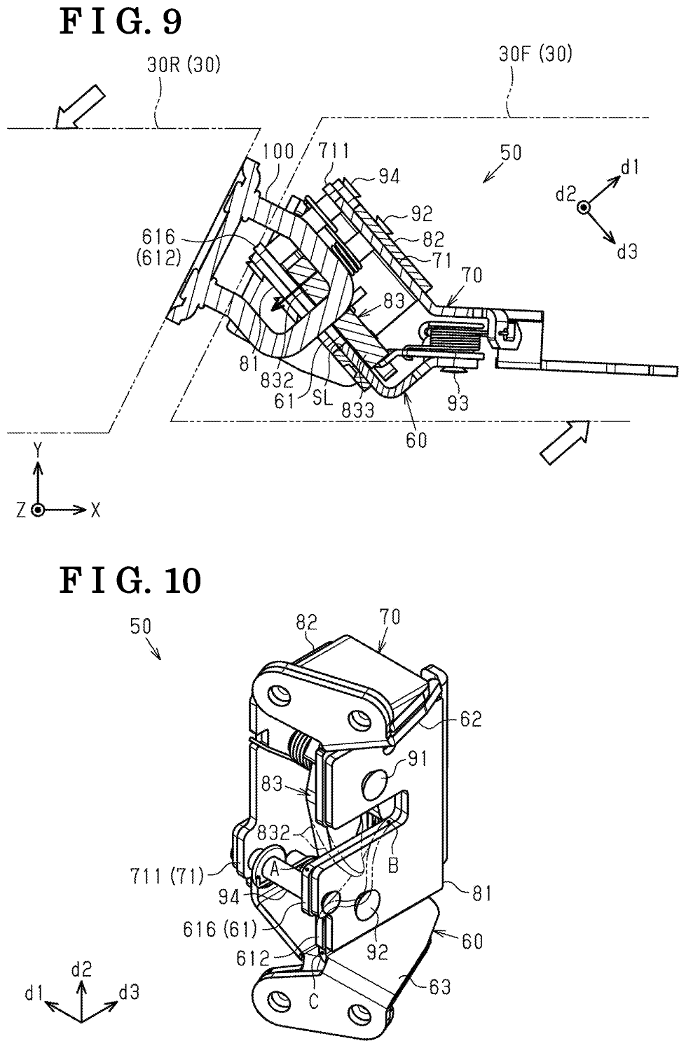

An operation of the center lock device 50 when an impact acts on the vehicle 10 in a situation where the slide door 30 is positioned at the fully-closed position will be described with reference to FIGS. 9 and 10.

When an impact acts on the vehicle 10, such as when another vehicle collides with a side surface of the vehicle 10, the front door 30F and the rear door 30R may be displaced with respect to each other as indicated by a white arrow in FIG. 9. In other words, as indicated by a white arrow in FIG. 7, the center striker 100 may be displaced with respect to the center lock device 50. In this case, a load indicated by a solid arrow acts on the first protrusion 832 of the latch 83 when the first protrusion 832 is pushed by the center striker 100. As a result, the first main plate 61 and the first reinforcing plate 81 of the first base 60 may be deformed together with the latch 83 in a direction indicated by the solid arrow by being pushed by the first protrusion 832 of the latch 83.

As shown in FIG. 10, the first protrusion 832 of the latch 83 has a fixed end at a base end portion and a free end at a tip end portion like a so-called cantilever beam. As a result, when a load as indicated by a solid arrow in FIG. 9 acts on the first protrusion 832 of the latch 83, the latch 83 may be deformed as indicated by a two-dot chain line in FIG. 10. Further, the latch 83 is adjacent to the pawl support wall 612 of the first base 60 in a deformation direction of the first protrusion 832. Therefore, when the latch 83 is deformed as indicated by the two-dot chain line in FIG. 10, the pawl support wall 612 may be similarly deformed.

Here, the center lock device 50 according to the present embodiment includes the coupling shaft 94 that couples the pawl support wall 612 of the first base 60 and the second main plate 71 of the second base 70. Therefore, the load acting on the pawl support wall 612 is distributed to the second main plate 71 via the coupling shaft 94. Therefore, as indicated by the two-dot chain line in FIG. 10, deformation of the first protrusion 832 of the latch 83 and deformation of the pawl support wall 612 of the first base 60 are prevented.

### Effects of the Present Embodiment

(1) The center lock device 50 includes the coupling shaft 94 that couples the first base 60 and the second base 70. Therefore, even when the latch 83 pushes the first base 60 when the impact acts on the vehicle 10, the force transmitted to the first base 60 via the latch 83 is distributed to the second base 70 via the coupling shaft 94. Therefore, in the center lock device 50, deformation of the first base 60 can be prevented as indicated by the two-dot chain line in FIG. 10. Thus, in the center lock device 50, the coupling strength of the latch 83 to the center striker 100 can be increased.

(2) In the center lock device 50, the coupling shaft 94 has the configuration same as that of the latch support shaft 91 and the pawl support shaft 92. Therefore, the structure of the center lock device 50 is simplified as compared with a case where a bracket that couples the first base 60 and the second base 70 is separately provided.

(3) In the center lock device 50, the pawl support wall 612 of the first main plate 61 is coupled to the second base 70 via the coupling shaft 94. Therefore, when an impact acts on the vehicle 10, in the center lock device 50, deformation of the pawl support wall 612 of the first main plate 61, which is easily deformed at a point adjacent to the slit SL, can be prevented.

(4) In the center lock device 50, the coupling shaft 94 is fixed to a largely deformable portion of the pawl support wall 612 of the first main plate 61. Therefore, in the center lock device 50, deformation of the pawl support wall 612 of the first main plate 61 can be effectively prevented.

(5) In the center lock device 50, the first main plate 61 is reinforced by the first reinforcing plate 81. Therefore, in the center lock device 50, deformation of the first base 60 when an impact acts on the vehicle 10 can be prevented. Further, in the center lock device 50, deterioration of press formability of the first base 60 can be prevented because the plate thickness of the first main plate 61 is not increased.

(6) In the center lock device 50, the second main plate 71 is reinforced by the second reinforcing plate 82. Therefore, in the center lock device 50, deformation of the second base 70 when an impact acts on the vehicle 10 can be prevented. Further, in the center lock device 50, deterioration of press formability of the second base 70 can be prevented because the plate thickness of the second main plate 71 is not increased.

(7) One end of the pawl spring 96 is locked to the pawl 84, and the other end of the pawl spring 96 is locked to the coupling shaft 94. Therefore, the center lock device 50 does not need to be provided with a configuration for locking the other end of the pawl spring 96 to the first base 60 or the second base 70.

### Modification

The present embodiment can be modified as follows. The present embodiment and the following modifications can be implemented in combination with each other as long as the present embodiment and the modifications do not have technical contradiction.

The coupling shaft 94 may be any coupling member that couples the first base 60 and the second base 70 in the first direction d1. For example, the coupling member may be a bracket having an L shape or a C shape in a side view. In this case, the bracket is preferably fixed to the first base 60 and the second base 70 by a fastening member such as a bolt.

The coupling shaft 94 may have a threaded portion with which nuts are screwed at both end portions in the axial direction. In this case, both end portions of the coupling shaft 94 can be fixed to the first base 60 and the second base 70 by the nuts.

The first end of the coupling shaft 94 may be fixed to the latch support wall 611 of the first base 60. The first end of the coupling shaft 94 may be fixed to a portion of the pawl support wall 612 of the first base 60, except for the first extension wall 616.

In the example shown in FIG. 10, a portion of the first base 60 where the first main plate 61 is deformed most largely is a portion indicated by a point A. Therefore, it is preferable that a fixing portion of the first end of the coupling shaft 94 in the first main plate 61 is closer to the portion indicated by the point A. For example, it is preferable that the fixing portion of the first end of the coupling shaft 94 in the first main plate 61 is closer to the portion indicated by the point A than is the fixing portion of the first end of the pawl support shaft 92 in the first main plate 61.

In the example shown in FIG. 10, the first main plate 61 of the first base 60 is deformed so as to be valley-folded with a line segment coupling a point B and a point C as a boundary. Therefore, the fixing portion of the first end of the coupling shaft 94 in the first main plate 61 may be either one region including the point A between two regions obtained by dividing the first main plate 61 by the line segment coupling the point B and the point C.

The center lock device 50 may include a plurality of coupling shafts 94.

In the center lock device 50, at least one of the first reinforcing plate 81 or the second reinforcing plate 82 may be omitted.

The first reinforcing plate 81 does not need to cover the entire first main plate 61 of the first base 60. For example, the first reinforcing plate 81 may cover at least the pawl support wall 612 of the first main plate 61. The same applies to the second reinforcing plate 82.

A method for fixing the first main plate 61 of the first base 60 and the first reinforcing plate 81 can be changed as appropriate. For example, the first main plate 61 and the first reinforcing plate 81 may be fixed by spot welding, or may be fixed using a fastening member such as a bolt. The same applies to a method of fixing the second main plate 71 of the second base 70 and the second reinforcing plate 82.

The front door 30F may include the center striker 100 instead of the center lock device 50. In this case, the rear door 30R preferably includes the center lock device 50 instead of the center striker 100.

The center lock device 50 according to the above embodiment can also be a door lock device that restrains a single door for opening and closing the door opening portion 21 onto the vehicle body 20. In this case, one of the vehicle body 20 and the door may include the center lock device 50, and the other one of the vehicle body 20 and the door may include the center striker 100.

A door to which the center lock device 50 is applied may be a swing door or a back door.

Hereinafter, a method for solving the problem of the related art and functions and effects thereof will be described.

According to an aspect of this disclosure, a vehicle door lock device includes: a latch configured to rotate between a fully-latched position where the latch is lockable to a striker and an unlatched position where the latch is unlockable to the striker; a pawl configured to rotate between a restriction position where a rotation of the latch from the fully-latched position to the unlatched position is restricted and a permission position where the rotation of the latch from the fully-latched position to the unlatched position is permitted; a latch support shaft that rotatably supports the latch; a pawl support shaft that rotatably supports the pawl; a first base to which a first end of the latch support shaft and a first end of the pawl support shaft are fixed; a second base to which a second end of the latch support shaft and a second end of the pawl support shaft are fixed; and a coupling member that couples the first base and the second base. A first end of the coupling member is fixed to the first base, and a second end of the coupling member is fixed to the second base.

It is preferable that, in the vehicle door lock device, the coupling member is a coupling shaft extending along the latch support shaft and the pawl support shaft.

When an impact acts on the vehicle, a load may act on a coupling portion between the vehicle door lock device and the striker. In this case, for example, when the striker is moved in an axial direction of the latch support shaft, the latch pushed by the striker may be deformed in the same direction. Further, the first base pushed by the latch may be deformed in the same direction. In such a situation, there is a concern that a coupling strength of the latch to the striker may decrease as a locked state of the latch to the striker changes.

In this regard, the vehicle door lock device having the above configuration includes the coupling member that couples the first base and the second base. Therefore, even when the latch pushes the first base, a force transmitted to the first base via the latch is distributed to the second base via the coupling member. Therefore, in the vehicle door lock device, deformation of the first base can be prevented. Thus, in the vehicle door lock device, the coupling strength of the latch to the striker can be increased.

In the vehicle door lock device, the coupling member can be configured as a coupling shaft equivalent to the latch support shaft and the pawl support shaft. Therefore, a structure of the vehicle door lock device is simplified.

It is preferable that, in the vehicle door lock device, the first base includes a plate-shaped first main plate provided with a slit through which the striker passes while a door is being opened and closed, the latch includes a base portion supported by the latch support shaft, and a locking portion extending from the base portion in a direction intersecting an axis of the latch support shaft and locked to the striker when the latch is positioned at the fully-latched position, the first main plate includes a first wall portion and a second wall portion that are positioned with the slit interposed therebetween, the first end of the latch support shaft is fixed to the first wall portion of the first main plate, and the first end of the coupling shaft is fixed to the second wall portion of the first main plate, and assuming that an axial direction of the latch support shaft is a first direction, when the latch is viewed from the first direction in a state where the latch is in the fully-latched position, a tip end of the locking portion of the latch overlaps the second wall portion of the first main plate.

When an impact acts on the vehicle, the first base pushed by the latch may be deformed. Specifically, the second wall portion of the first main plate of the first base may be deformed by being pushed by the tip end of the locking portion of the latch. In this regard, in the vehicle door lock device, the second wall portion of the first main plate is coupled to the second base via the coupling shaft. Therefore, in the vehicle door lock device, deformation of the second wall portion of the first main plate, which is easily deformed at a point adjacent to the slit, can be prevented.

It is preferable that, in the vehicle door lock device, assuming that a width direction of the slit is a second direction and an extending direction of the slit is a third direction, the first base includes two first fixing plates respectively extending from both sides of the first main plate in the second direction, one of the two first fixing plates extends from the first wall portion, and the other one of the two first fixing plates extends from the second wall portion, and when the second wall portion of the first main plate is viewed from the first direction, the coupling shaft is positioned closer in the second direction to a surface of the second wall portion facing the slit than to a boundary between the second wall portion and the first fixing plate, and is positioned closer in the third direction to an opening of the slit than to a bottom portion of the slit.

The first end of the coupling shaft is fixed to a largely deformable portion of the second wall portion of the first main plate. Therefore, in the vehicle door lock device, deformation of the second wall portion of the first main plate can be effectively prevented.

It is preferable that the vehicle door lock device further includes a plate-shaped first reinforcing plate that reinforces the first base, in which the first base includes a plate-shaped first main plate to which the first end of the latch support shaft and the first end of the pawl support shaft are fixed, and the first reinforcing plate is fixed to the first main plate in a state of being stacked on the first main plate.

In the vehicle door lock device, the first main plate is reinforced by the first reinforcing plate. Therefore, in the vehicle door lock device, deformation of the first base can be prevented when an impact acts on the vehicle.

It is preferable that the vehicle door lock device further includes a plate-shaped second reinforcing plate that reinforces the second base, in which the second base includes a plate-shaped second main plate to which the second end of the latch support shaft and the second end of the pawl support shaft are fixed, and the second reinforcing plate is fixed to the second main plate in a state of being stacked on the second main plate.

In the vehicle door lock device, the second main plate is reinforced by the second reinforcing plate. Therefore, in the vehicle door lock device, deformation of the second base can be prevented when an impact acts on the vehicle.

The vehicle door lock device can increase a coupling strength to a striker.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door lock device comprising:
a latch configured to rotate between a fully-latched position where the latch is lockable to a striker and an unlatched position where the latch is unlockable to the striker;
a pawl configured to rotate between a restriction position where a rotation of the latch from the fully-latched position to the unlatched position is restricted and a permission position where the rotation of the latch from the fully-latched position to the unlatched position is permitted;
a latch support shaft that rotatably supports the latch;
a pawl support shaft that rotatably supports the pawl;
a first base to which a first end of the latch support shaft and a first end of the pawl support shaft are fixed;
a second base to which a second end of the latch support shaft and a second end of the pawl support shaft are fixed; and
a coupling member that couples the first base and the second base, wherein
a first end of the coupling member is fixed to the first base, and a second end of the coupling member is fixed to the second base.

2. The vehicle door lock device according to claim 1, wherein
the coupling member is a coupling shaft extending along the latch support shaft and the pawl support shaft.

3. The vehicle door lock device according to claim 2, wherein
the first base includes a plate-shaped first main plate provided with a slit through which the striker passes while a door is being opened and closed,
the latch includes a base portion supported by the latch support shaft, and a locking portion extending from the base portion in a direction intersecting an axis of the latch support shaft and locked to the striker when the latch is positioned at the fully-latched position,
the first main plate includes a first wall portion and a second wall portion that are positioned with the slit interposed therebetween,
the first end of the latch support shaft is fixed to the first wall portion of the first main plate, and the first end of the coupling shaft is fixed to the second wall portion of the first main plate, and
assuming that an axial direction of the latch support shaft is a first direction,
when the latch is viewed from the first direction in a state where the latch is in the fully-latched position, a tip end of the locking portion of the latch overlaps the second wall portion of the first main plate.

4. The vehicle door lock device according to claim 3, wherein
assuming that a width direction of the slit is a second direction and an extending direction of the slit is a third direction,
the first base includes two first fixing plates respectively extending from both sides of the first main plate in the second direction,
one of the two first fixing plates extends from the first wall portion, and the other one of the two first fixing plates extends from the second wall portion, and
when the second wall portion of the first main plate is viewed from the first direction, the coupling shaft is positioned closer in the second direction to a surface of the second wall portion facing the slit than to a boundary between the second wall portion and the first fixing plate, and is positioned closer in the third direction to an opening of the slit than to a bottom portion of the slit.

5. The vehicle door lock device according to claim 1, further comprising:
a plate-shaped first reinforcing plate that reinforces the first base, wherein
the first base includes a plate-shaped first main plate to which the first end of the latch support shaft and the first end of the pawl support shaft are fixed, and
the first reinforcing plate is fixed to the first main plate in a state of being stacked on the first main plate.

6. The vehicle door lock device according to claim 1, further comprising:
a plate-shaped second reinforcing plate that reinforces the second base, wherein
the second base includes a plate-shaped second main plate to which the second end of the latch support shaft and the second end of the pawl support shaft are fixed, and
the second reinforcing plate is fixed to the second main plate in a state of being stacked on the second main plate.
